(19) United States
(12) Patent Application Publication
(10) Pub. No.: US 2002/0006357 A1
(43) Pub. Date: Jan. 17, 2002

(54) Biological ion channels in nanofabricated detectors

(76) Inventors: Julie E.M. McGeoch, Little Compton, RI (US); Malcolm W. McGeoch, Little Compton, RI (US)

Correspondence Address: Timothy J. Oyer, Wolf, Greenfield & Sacks, P.C., 600 Atlantic Avenue, Boston, MA, 02210, US

(21) Appl. No.: 09/844,516

(22) Filed: Apr. 27, 2001

Related U.S. Application Data
(63) Continuation of application No. PCT/US99/24043, filed on Oct. 22, 1999.
(60) Provisional application No. 60/105,842, filed on Oct. 27, 1998.
(60) Provisional application No. 60/140,111, filed on Jun. 18, 1999.

(51) Int. Cl. G01N 27/26; G01N 27/40; G01N 27/416

(52) U.S. Cl. 422/82.01; 436/149; 204/514; 204/415

(57) ABSTRACT

The present invention relates to a device for generating an oscillating electrical current, where the device incorporates an ion channel. In particular, the ion channel is incorporated into an integrated electronic device having nanoscale dimensions. Thus, this device can transform biological processes into an electrical output. The present invention also describes a sensor for detecting biological or chemical analytes with the ion channel device. Methods for generating the oscillating currents and detecting the analytes are also disclosed.

### RELATED APPLICATIONS

This application is a continuation of International Patent Application Ser. No. PCT/US99/24043, filed Oct. 22, 1999, which claims priority to U.S. Provisional Application Ser. Nos. 60/105,842, filed Oct. 27, 1998 and 60/140,111, filed Jun. 18, 1999.

### GOVERNMENT SUPPORT

This invention was supported by the Office of Naval Research (ONR), Grant No. N00014-97-1-0654 and the U.S. government has certain rights in the invention.

### FIELD OF THE INVENTION

The present invention relates to a biological/electronic interface, and more particularly to a device for generating an oscillating electrical current that incorporates a biological ion channel.

### BACKGROUND OF THE INVENTION

Nature has devised a large number of methods to transport or conduct charge across biological interfaces. Accordingly, there has been a concerted effort to exploit this biological conductivity by either (1) preparing synthetic mimics of the biological conductor or (2) by using the actual biological conductor. The second approach is particularly attractive because many of these biological species have structures that are too sophisticated to easily mimic. Such in vitro use, however, can present the disadvantage of a lack of stability of the biological species when placed in an unnatural environment.

One example of transporting charge in biology occurs when ions are conducted across cell membranes through membrane proteins, for example ion channels or ion pumps. With an ion channel, the ions move through the channel in a thermodynamically downhill direction. In the case of ion pumps, the ions travel through the pumps in a thermodynamically uphill direction, and thus need an energy source to carry out this energetically unfavorable process.

FIG. 1 illustrates a schematic example of a membrane 2. The membrane comprises a lipid bilayer 4 having, interspersed within, biological species 6 having a pore 7, of an ion channel, allowing transport of ions from one side of the membrane to the other side. For example, ions can move from an area outside of a cell membrane, to an area inside of the membrane.

The movement of ions through the channels or pumps is not a free-flowing motion of ions, but rather the membrane regulates the flow of ions. FIG. 2 shows a similar diagram as FIG. 1, but illustrating the distribution of charges inside and outside of a membrane wall. Typically, the inside of a membrane is negatively charged, i.e., the inside has an excess of negatively charged species, whereas the outside of a membrane is positively charged. The inside of a membrane can have a potential of between about −60 mV to about −100 mV relative to the outside. Due to this separation of charged species, the membrane is said to be in a “polarized state”. When the membrane is polarized to a threshold extent, the pore 7 of the ion channel of biological species 6 is in an “open state” because a positively charged cation can travel from the side of the membrane having an excess of positively charged species to the inside of the membrane having negatively charged species as dictated by thermodynamics.

As mentioned previously, the pore of the ion channel is not always in an open state where cations can move freely through the pore. Certain events can cause the pore to close, precluding the transport of ions through the membrane. These events are regulated by the cell. For example, the ion channel can be “ligand-gated”, where the event that causes pore closings involves the binding of a ligand, i.e. an external biological or chemical species, to the ion channel. This binding can affect the conformation of bonds within the ion channel, causing the pore to close. In another example, the cell can regulate the flow of cations by “voltage-gating”. Here, the distribution of charges between the outside and inside of the membrane is either reversed, decreased, or absent. By either of these events, the thermodynamics that drive the cation to travel from the outside to the inside of the cell is thereby decreased, and the pore is said to be “depolarized.”

Over time, the charges can re-redistribute, in the case of voltage-gating, or the ligand can diffuse away from the binding site of the ion channel (causing redistribution of charges), in the case of ligand-gating. The pore can then re-achieve the open or polarized state. Through the repetitive closing and opening of the ion channel pore, movement of charge through the membrane wall occurs as a series of oscillations having a particular oscillation frequency.

Because the species moving through the oscillating ion channel is charged, there exists a capability to convert this oscillating movement of charges into an oscillating electrical current, allowing the membrane to act as an interface for a biological to electronic transition. This has been useful for, among other reasons, investigations of ion transport across membranes. Various devices to achieve this oscillating electrical current have been previously reported. The general operating principle of this device involves a membrane acting as an interface between two electrolyte solutions, resulting in an electrolyte solution on either side of the membrane. Electrodes can be disposed within each of the electrolyte solutions where the electrodes are connected to voltage sources and current detectors and where necessary. Thus, upon applying a voltage, the distribution of charges about the membrane is affected and an oscillating electrical current can be generated.

One such device known in the art is a patch clamp. FIG. 3A illustrates a typical patch clamp. The patch clamp 10 comprises a glass pipet 11 having an electrolyte solution 13. The inset of FIG. 3A shows an expanded view of the tip of the pipet. The tip features a lipid membrane 15 which extends across the diameter of the tip. Membrane 15 includes an ion channel pore 16. The membrane can be a single cell or comprise protein reconstituted within a lipid bilayer. Typically, the diameter of the tip is 1 μm. As shown in the inset, the glass pipet has one electrolyte solution 13 situated on one side of membrane 15 and electrolyte solution 14 situated on the other side of membrane 15. Electrodes 19 and 20 can be immersed into electrolyte solution 13 and 14 respectively, where the electrodes are also connected to amplifier head 18.

FIG. 3B shows a plot of oscillating electrical current as a function of time. As time progresses, short bursts of electrical current are generated. These bursts can range in the order of milliseconds to seconds, depending on the oscillating frequency. The patch clamp represented a significant advancement in the field, especially by providing increased sensitivity.

The principles of the patch clamp have been used to prepare several other related devices. U.S. Pat. No. 5,516,890 (Tomich et al.) and U.S. Statutory Invention Registration No. H201 (Yager) both relate to patch clamp-type devices. Yager teaches incorporating proteins into synthetic membranes and Tomich discloses the use of synthetic proteins that mimic ion channels. U.S. Pat. Nos. 5,503,744 and 5,378,342 (both Ikematsu et al.) relate to biological oscillating devices comprising a lipid membrane having ion pumps, where the membrane is situated between two electrolyte solutions. The device is activated by an energy source such as light. U.S. Pat. No. 5,225,374 (Fare et al.) relates to a sensor. The sensor includes a porous semiconductor substrate having a lipid bilayer with receptor or protein pores, where the bilayer is positioned on the substrate.

While the above and other reports represent, in many cases, useful biological/electronic interfaces, there remains a need to prepare devices for generating oscillating electrical currents having increased sensitivity and lifetimes. In addition, there exists a need to fabricate such devices in nanoscale dimensions. In addition, sensors for detecting various biological or chemical analyzers need to be developed to detect analytes at very low concentrations with increased sensitivity.

### SUMMARY OF THE INVENTION

The present invention provides a series of devices, including oscillating current generators and sensors, and methods relating to biological/electronic interfaces. In one aspect of the invention, a series of devices are provided. One device is defined by an electrical insulator having a first side and a second side. The insulator includes at least one hole that penetrates it and passes from the first side to the second side. At least one pore is positioned within the hole. The pore can exist in an open or closed state, where the closed state prevents ionic communication across the pore and the open state allows ionic communication across the pore from the first side to the second side of the insulator.

In another embodiment a device is provided for generating an oscillating current. The device is similar to that described above, and the insulating layer is positioned between two electrolyte reservoirs. A negative bias electrode and a positive bias electrode each have one end in electrical communication with respective electrolyte reservoirs, with the other ends of the electrodes being connected to a voltage source for applying a voltage. A current detector also is provided for measuring current responsive to application of the voltage.

In another embodiment a device as described above includes an electrical circuit in electrical communication with first and second sides of the insulator, but not necessarily as described in the paragraph immediately above. The electrical circuit is constructed and arranged to determine a change in an electrical characteristic across the at least one pore within each hole. This change in electrical characteristic can be a change in current, a change in voltage, or other electrical signal representative of a change in ionic transport characteristic across the pore.

In another embodiment a device is provided for generating an oscillating current. The device includes an oscillating ion channel, where the ion channel is positioned within a membrane spanning a hole having a diameter less than one micron.

In another aspect a sensor is provided. The sensor can be a device as described above, or can include an insulating layer, negative and positive electrodes each in electrical communication with an opposing side of the insulating layer, at least one hole penetrating the insulating layer, and an ion channel positioned within the hole.

Another device of the invention includes a first electrolyte reservoir, a second electrolyte reservoir, and electrical circuitry connecting the first and second electrolyte reservoirs. Subunit c of ATP synthase separates the first and second electrolyte reservoirs.

Another device of the invention includes a barrier having a first side and a second side. A pore is located in the barrier, which can exist in an open state or a closed state. The closed state prevents ionic communication across the pore and the open state allows ionic communication across the pore from the first side of the barrier to the second side. An electrolyte container, constructed and arranged to contain an electrolyte and to position the electrolyte in contact with the first side of the pore is provided, and a second electrolyte container, constructed and arranged to contain an electrolyte and to position the electrolyte in contact with a second side of the pore, is fastenable to the first electrolyte container.

In another embodiment a device of the invention includes a barrier having two sides and including a pore, a described in the above paragraph. A first electrolyte container, constructed and arranged to contain an electrolyte and to position the electrolyte in contact with the first side of the pore is fastenable to the barrier. A second electrolyte container, also fastenable to the barrier, is constructed and arranged to contain an electrolyte and to position the electrolyte in contact with a second side of the pore.

In another embodiment a device includes a barrier having a first side and a second side, and a pore in the barrier as described in the above paragraph. A first electrolyte container includes container interior walls integral with the barrier, and a second electrolyte container also contains container interior walls integral with the barrier.

In another aspect a series of methods is provided. One method involves providing one or more membranes each positioned between two electrolyte reservoirs. Each membrane has at least one oscillating ion channel. The method involves measuring an electrical output from at least one oscillating ion channel in each membrane, or simultaneously measuring an electrical output from two or more oscillating ion channels.

Another method of the invention involves detecting a sample of analyte. The method involves providing at least one ion channel oscillating at a first frequency. A sample is allowed to bind to the at least one ion channel to cause the channel to oscillate at a second frequency, and the second frequency then is measured.

Another method of the invention involves sensing an analyte. In the method, an ion channel is allowed to oscillate at a relatively steady frequency for a period of time of at least about one second. Then, the ion channel is exposed to an analyte that affects the oscillation frequency of the channel and this change is detected indicating presence of the analyte.

Another method of the invention involves allowing an ion channel to oscillate at a frequency, as a signal, and amplifying the signal and detecting the resulting amplified signal. This can find use in a sensor, or an oscillator.

Another method of the invention involves providing at least two separate membranes positioned adjacent at least one electrolyte reservoir, each membrane having at least one oscillating ion channel. An electrical output from at least one oscillating ion channel in each membrane is simultaneously measured.

In another embodiment a device is provided that includes an ion channel capable of oscillation, and an electrical amplifier in electrical communication with the ion channel. The device can include an electrical insulator having a first side and a second side and at least one hole penetrating the insulator. At least one pore is positioned within the hole and can exist in one of an open and a closed state wherein the closed state prevents ionic communication and the open state allows ionic communication. An amplifier is provided, constructed and arranged to electrically amplify an oscillating signal produced by opening and closing of the pore.

Other advantages, novel features, and objects of the invention will become apparent from the following detailed description of the invention when considered in conjunction with the accompanying drawings, which are schematic and which are not intended to be drawn to scale. In the Figures, each identical or nearly identical component that is illustrated in various Figures is represented by a single numeral. For purposes of clarity, not every component is labeled in every Figure, nor is every component of each embodiment of the invention shown where illustration is not necessary to allow those of ordinary skill in the art to understand the invention.

### BRIEF DESCRIPTION OF THE DRAWINGS

FIG. 1 shows a schematic representation of a membrane;

FIG. 2 illustrates a schematic representation of a membrane, and highlights the distribution of charges on either side of the membrane and the direction of cation flow;

FIG. 3A shows a diagram of a patch clamp and an expanded view of the tip of the patch clamp;

FIG. 3B shows a plot of current vs. time, highlighting the bursts of electrical current generated;

FIG. 4A illustrates a schematic representation of an ion channel within a lipid membrane, where the ion channel is formed from a circular array of protein subunits;

FIG. 4B shows a helical representation of bovine F₀ subunit c, as modeled from a possible structure of E. Coli;

FIG. 5 shows a proposed mechanism for oscillation of a sodium/calcium ion channel;

FIG. 6A shows a side view of a schematic representation of a biological oscillating device;

FIG. 6B shows a top view of the device of FIG. 6A;

FIGS. 7A and 7B show schematic representations of a sensor disposed on a chip, where the sensor has an array of 16 holes having membranes containing ion channels;

FIGS. 8A and 8B show photocopies of scanning electron micrograph (SEM) images of nanofabricated holes in SiNₓ membranes, patterned by direct-write electron beam lithography and reactive ion etching;

FIG. 9 shows plots of current vs. time where the ion pore is located within the nanofabricated device;

FIG. 10 illustrates schematically a sensor according to one embodiment of the invention;

FIGS. 11A and 11B illustrate schematically a sensor according to yet another embodiment of the invention; and

FIG. 12 illustrates, schematically, a hole within a barrier, including a barrier thin film, lipid bilayer membrane, and biological ion channel of a device according to one embodiment of the invention.

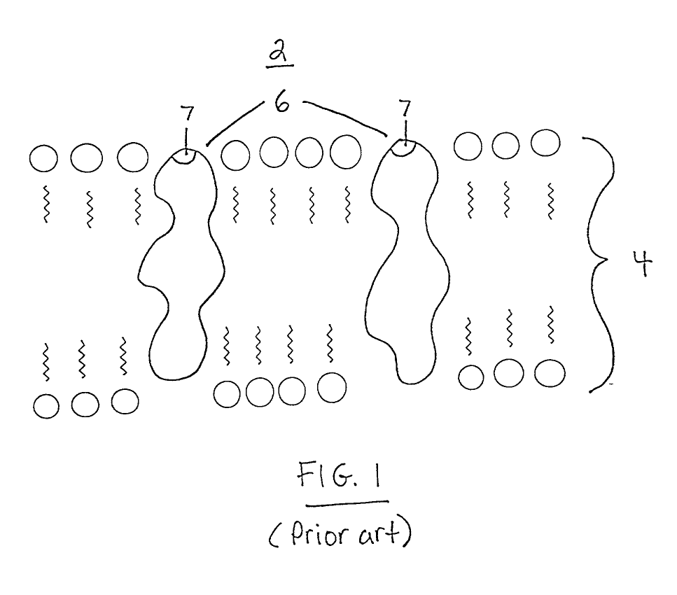

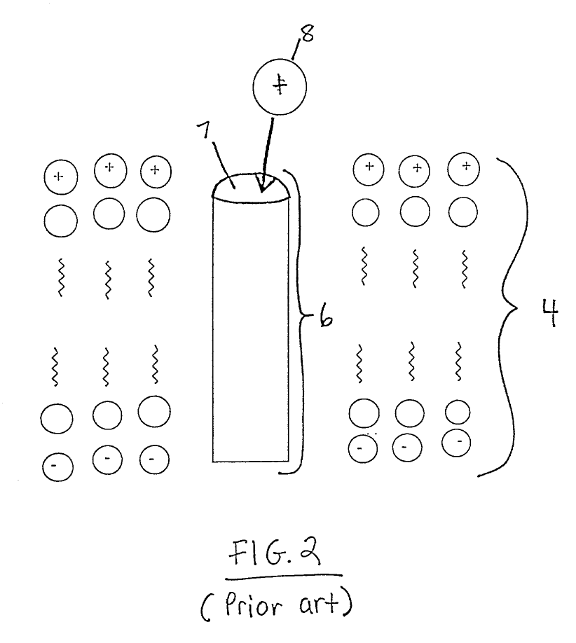

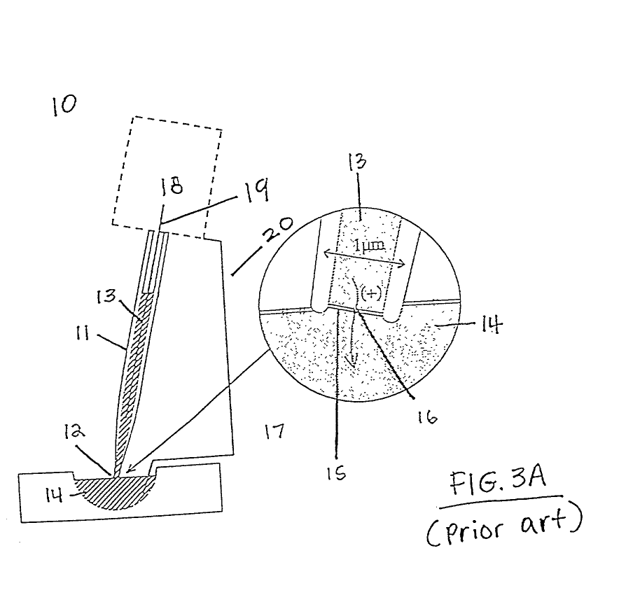

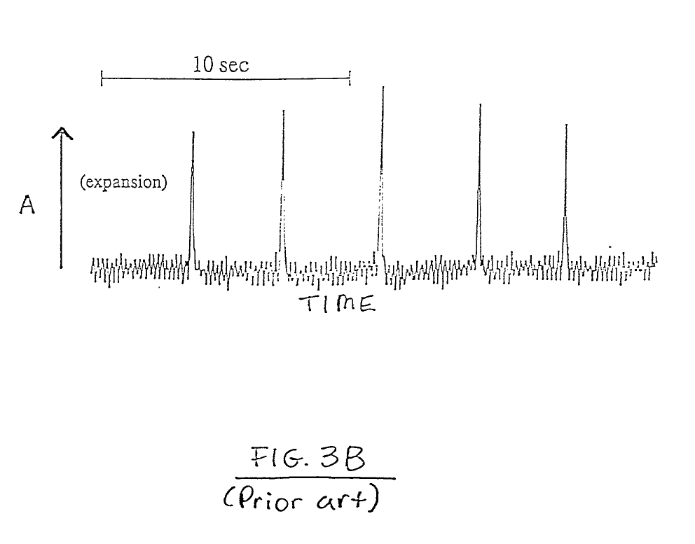

### DETAILED DESCRIPTION

The present invention relates to electronic/biological interface devices having improved sensitivity, accuracy, and/or packaging. The devices can convert biological charge transport processes at ion channels into an electrical output. The invention includes sensor packaging arrangements that are simple, compact, easy to manufacture in bulk, and facilitate exposure of both sides of ion channels to different electrolyte solutions. The invention also provides devices having one or more holes in an insulator, each including an ion channel, to provide statistical accuracy and increased signal intensity; small holes, allowing increased sensitivity and an ability to fabricate nanoscale devices; and amplification of output electrical signal.

One aspect of the present invention is a device for generating an oscillating electric current resulting from the transport of ionic charge, such as cations or anions, through a membrane which typically comprises a lipid bilayer including various membrane proteins arranged to form at least one ion channel including a pore. The channel can be formed of any membrane protein or protein combination that allows ion transport from one side of the membrane to the other side through the pore in the channel and is capable of oscillating between an open state and a closed state. The oscillations can occur at a frequency of between about 0.1 Hz to about 700 Hz. When the pore is in an “open state,” ions can travel through the membrane by entering one end of the pore and exiting through the other end. When the pore is in a “closed state,” the membrane is impermeable to ions in the vicinity of the closed pore. When the pore is in an open state, the diameter of the pore i.e. the diameter of the opening of the pore, is less than about 20 Å and preferably the diameter is between about 3 Å and about 10 Å.

In one embodiment of the device, the ions are positioned in ionic communication with the membrane. “Ionic communication” in this context, means positioned so as to be ionically transferred to the membrane via, for example, electrolyte. In preferred arrangements, two electrolyte reservoirs are separated by an electrically insulating barrier including the membrane. The insulating layer can include a ceramic, such as an oxide (e.g. silicon oxide), a nitride (e.g. silicon nitride), a carbide, a carbon-based material such as diamond or diamond-like carbon (e.g., graphite/diamond combination), polymer, or any other appropriate insulating material. The electrolyte reservoirs can be either an electrolyte solution, a solid electrolyte, a gel, or the like. One suitable arrangement includes an electrical insulating barrier having a first side and a second side and a hole passing from the first side to the second side, penetrating the barrier. The membrane, comprising a lipid bilayer and at least one pore, defines a component of the barrier and is positioned within the hole and separates the electrolyte reservoirs. When the pore is in an open state, ionic communication between the reservoirs is possible i.e. ions from one electrolyte reservoir can travel through the pore to the other reservoir to generate an electrical current. A pore in a closed state prevents ionic communication between the electrolyte reservoirs.

Suitable electrical circuitry can be provided to electrically address electrolytes on either side of the barrier. The circuitry can include two electrodes such as a positive bias electrode and a negative bias electrode, one end of each electrode contacting the respective electrolyte reservoirs, i.e. one end of the positive bias electrode can be partially immersed in one electrolyte reservoir and one end of the negative bias electrode partially immersed in the other electrolyte reservoir. The other ends of the electrodes can be connected to a plurality of electrical instruments, such as a voltage source for applying a voltage and a current detector for measuring current. Application of a voltage can cause a change in the membrane potential, allowing the “open state” to occur and transport of charge through the pore to provide electrical current.

The device of the invention can be constructed as a sensor with the electrical circuitry set to conditions that provide a detectable current. In one embodiment, applying a voltage of between about 60 mV to about 100 mV generates a current of at least about 10 pA, preferably at least about 50 pA, more preferably at least about 100 pA and even more preferably at least about 200 pA. The device can include an amplifier to amplify the magnitude of the generated current. This embodiment provides an additional method to maximize the amount of current.

In preferred embodiments, devices of the invention include a single pore, in a membrane positioned within a small hole of an insulating barrier. In such an arrangement, small holes are desired. Accordingly, a device having nanoscale dimensions, such as the dimensions found in a silicon chip, with a pore-containing hole having a diameter of less than about 1 μm, preferably less than about 500 nm, and more preferably less than about 200 nm, is preferred.

Accuracy of the device can be improved by obtaining a statistical number of electrical events. Toward that end, one embodiment provides an insulating layer having at least two holes and membranes comprising at least one pore positioned within each of the holes. Each of the holes can have a diameter as described previously. The at least two holes can be an array of holes, such as an n×m matrix where n and m can be the same or different and at least one of n and m is an integer of at least 2. Where a single pore exists in each hole, this arrangement provides an n×m matrix array of holes, and of pores. Arrays of essentially any size can be used, including arrays of 8×8 or larger. When the arrays comprise a large number of holes, providing holes of small diameters as described above can be especially advantageous. Such a device can simultaneously generate an oscillating current from at least two pores and, consequently, simultaneously measure the current from the at least two pores. Where two or more pores are arranged in a single device (i.e., a single pore within each of two or more holes in an insulating barrier), a common electrolyte can be positioned on one side of the insulating barrier layer, and typically a different electrolyte is provided for each pore on the opposite side of the insulator.

The ion channel can comprise a closed ring array of biological species such as synthetic or naturally occurring proteins or protein subunits, or helices or other similar biological species. A variety of these biological species that form ion channels are well known in the art. The ion channel can be a cation channel selected from the group consisting of a sodium ion channel, a potassium ion channel, a calcium ion channel or any combination thereof. The biological species defining the channel can have an elongated shape (one dimension of the volume being substantially longer than the other two dimensions), where the long dimension defines the length of the channel and the proteins are positioned adjacent each other to form a closed ring. The resulting pore can have a circular or oval shape or any other closed shape. In one embodiment, the closed ring array comprises at least 3 protein subunits, preferably between 3 and 15 protein subunits and more preferably between 6 and 12 protein subunits.

It has been found that subunit c of ATP synthase, and its derivatives, is a robust, stable, and useful pore for use in the invention. Accordingly, a particularly preferred aspect of the invention includes subunit c of ATP synthase separating electrolyte reservoirs each connected to electrical circuitry defining a sensor.

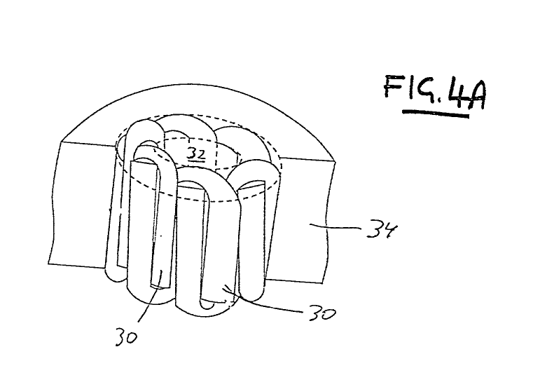

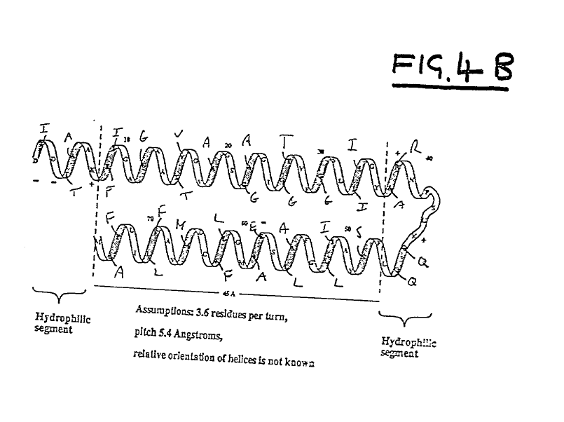

FIG. 4A shows an embodiment of an ion channel comprising a closed ring array of 12 protein subunits 30, for example subunit c of ATP synthase, situated within a membrane. In this embodiment, the resulting ion channel is a calcium/sodium ion channel. The subunits are of a dimension to provide a pore 32 in the middle of the closed ring array. The protein subunits 30 defining the pore 32 are surrounded by a lipid membrane 34. FIG. 4B shows a modeled possible structure of the helices of bovine F₀ subunit c, which has an elongated shape where the long dimension is approximately 45 Å. the 75 amino acid letter code sequence of subunit c as illustrated is DIDTAAKFIGAGAATVGVAGSGAGIGTVFGSLIIGYARNPSLKQQLFSYAILGFALSEAM GLFCLMVAFLILFAM. Subunit c of ATP synthase is a relatively small protein with a molecular weight of 7.6 kD.

Because the ion channel is to be positioned within an electronic device, the ion channel is preferably rugged and can withstand the operating conditions to maximize the lifetime of the device. In one embodiment, the ion channel is stable when stored in water or an organic solvent for at least 1 day. By “stable” it is meant that after storing the ion channel for 1 day, the ion channel can be incorporated into the device and generate an oscillating electrical current. In another embodiment, the ion channel has sufficient stability allowing it to be effective in an operative device for at least one day, that is, being electrically connected so as to oscillate constantly for at least one day.

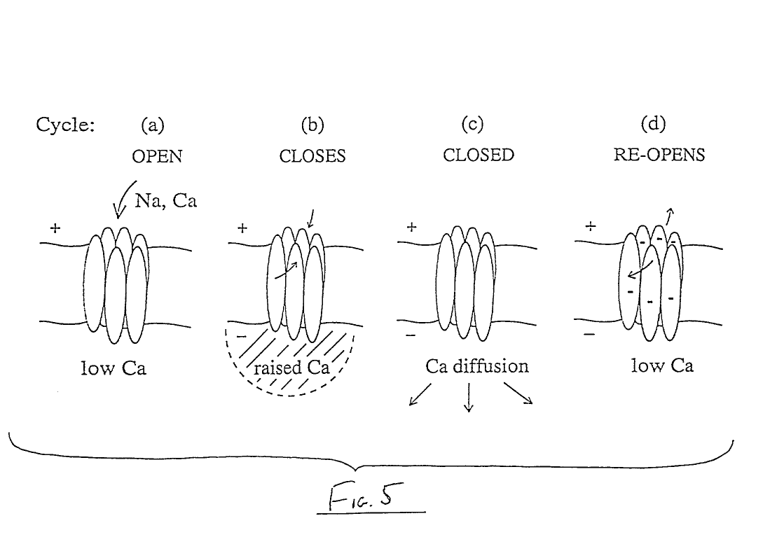

FIG. 5 shows a proposed mechanism for oscillation in a sodium/calcium ion channel. In (a), the negative potential side of the membrane has a low calcium concentration (less than 200 nm) which provides the pore in an open state. In this configuration, the pore can conduct mainly sodium current together with a small amount of calcium current. This conduction results in a build-up of calcium ion concentration on the negative potential side of the membrane (b). In (c) the high calcium concentration on the negative potential side of the membrane causes the pore to close. This closure results from the cooperative binding of several calcium ions to the pore, thought to be at least four calcium ions. After calcium diffusion from the ion channel, (d) shows the reconfiguration of the pore in an open state where the negative potential side once again has a low calcium ion concentration, as in FIG. 5(a).

Thus, the particular ion channels discussed in FIG. 5 have the advantageous feature of cooperative regulation by a number of calcium ions, or at least four calcium ions. The cooperative feature is significant, especially when considering that chemical energy is generated by the binding of each calcium ion on each protein subunit. For example, the binding of six calcium ions, where the binding of each calcium ion results in an energy gain of 0.5 eV, can produce a net energy total of 3 eV. As shown in the inset graph, this cooperative binding also results in a sharp transition between the open and closed state. A sharp transition allows the oscillation to occur very rapidly, which can provide increased resolution with respect to time.

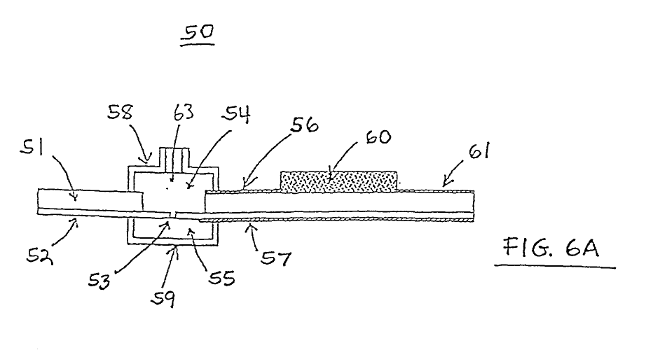

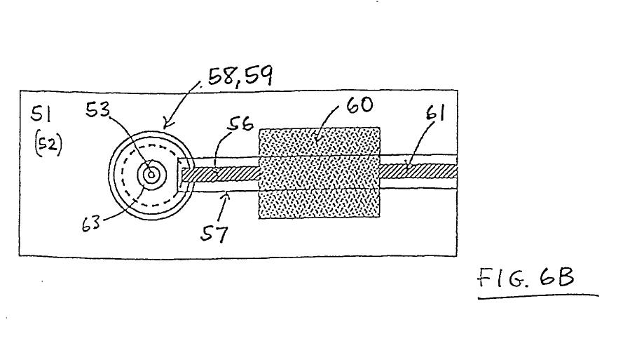

FIGS. 6A and 6B show schematic side and top views, respectively, of one embodiment of a device in accordance with the present invention. The device can be a sensor, a device for generating an oscillating current, or the like. The device is fabricated as a chip, as would be understood to those of ordinary skill in the art. In FIG. 6A, device 50 has an electrically insulating barrier defined by a silicon substrate 51 carrying a thin film insulating layer 52 (e.g. silicon nitride) positioned in electrical communication with an electrical circuit that is constructed and arranged to determine a change in an electrical characteristic across insulating layer 52. Specifically, the insulating layer is positioned between two electrolytes 54 and 55. Insulating layer 52 includes a hole 53 passing between the two electrolyte containers 58 and 59, respectively, itself spanned by an insulating lipid bilayer. The containers are constructed to contain electrolytes 54 and 55 and to position the electrolytes in contact with either side of insulator 52.

One important feature of the embodiment illustrated in FIGS. 6A and 6B is that each of electrolyte containers 58 and 59 include container interior walls that are integral with electrical insulating barriers defined by 51 and 52. “Integral with”, in this context, means that there is no route for electrolyte escape from the containers between the container interior walls and the barrier. As illustrated, the only passageway through a container wall that addresses electrolyte is passageway 63 that allows exposure of electrolyte 54 to analyte. In some cases, containers 58 and 59 can be removed from and re-attached to the electrically insulating barrier. In this case, each of electrolyte containers 58 and 59 is fastenable to the barrier. As used herein, “fastenable” means that the container is part of an overall device package in which the container is designed to be fastened to the barrier, either permanently or removably, via adhesive, snap-fit, auxiliary fasteners, or the like. Those of ordinary skill in the art will understand the meaning of “fastenable”, in this context, based upon this description and further description below.

Electrical circuitry is provided to electrically contact electrolytes within containers 58 and 59. As illustrated, a positive bias electrode 56 is partially immersed in the electrolyte 54 and a negative bias electrode 57 is partially immersed in the electrolyte 55. FIG. 6A depicts electrode 57 as being positioned adjacent one side of insulating layer 52 where 56 is seen as positioned against silicon substrate 51 which in turn is positioned against insulating layer 52. The electrodes can be further connected to an integrated circuit amplifier and bias generator 60.

Electrolyte 55 can include chelating agents to deplete the region of free conducted ions, such as calcium. This depletion, leading to a decreased concentration of free ions, will tend to increase the rate of diffusion of ions from the ion channel (see FIG. 5 and 5(d)).

FIG. 6B shows a top view of the device, highlighting hole 53 positioned within an electrolyte enclosure with access hole 63 for agents 58.

Another aspect of the invention provides a method for generating an oscillating current. The method comprises providing one or more ion channel pores which each can be contained within separate lipid bilayer membranes positioned between two electrolyte reservoirs. The reservoirs can be the same for both membranes where multiple membranes are used, or both membrane can only share one common reservoir, or have completely separate reservoirs. Thus, each membrane can provide ionic communication between the same two electrolyte reservoirs, through at least one oscillating ion channel, or provide ionic communication between individual electrolyte reservoirs to a common reservoir. In one embodiment, the method involves an array of holes. The method provides a simultaneous measurement of electrical output caused by the oscillating ion channels which provide an oscillating flow of charge. In one embodiment, the method can involve providing a device as previously described.

Another advantage of this method lies in the fact that the application of a voltage results in the oscillating electrical current. Thus, by applying a constant voltage the ion channel can oscillate. In one embodiment, the ion channel oscillates steadily for at least one day, i.e. the ion channel may cease to oscillate momentarily but the ion channel is capable of restarting the oscillations.

As mentioned, one aspect of the invention provides a sensor for detecting a sample of an analyte. The sensor includes an ion channel having the attributes described previously. In one embodiment, the ion channel is ligand-gated. By “ligand-gated,” any biological or chemical species that is capable of interacting or binding to the ion channel causes a change in the oscillation frequency, and examples of such biological or chemical species are disclosed in “Biochemistry” by L. Stryer (W. H. Freeman and Co., NY, 1995) which is hereby incorporated by reference in its entirety. Each analyte will change an ion channel's oscillating frequency to a second frequency that can be higher or lower than the initial or first frequency. Thus, the sensor operates under the principle that a particular analyte is detected when the second oscillation frequency occurs.

In one embodiment, the sensor includes a device for generating an oscillating current, as described previously, where the device includes at least one ion channel positioned within a barrier separating two electrolytes. An analyte can bind to an ion channel, changing its frequency of oscillation, and allowing sensing. For example, one electrolyte reservoir is exposed to an atmosphere suspected of containing the analyte. When the analyte eventually reaches the electrolyte, it diffuses through the electrolyte and eventually binds to the ion channel. The oscillating frequency of the ion channel can then change to a second frequency that can depend on the manner and extent of binding or interaction between the ion channel and the analyte.

In one embodiment, the sensor includes a detection instrument for detecting the change in frequency. In another embodiment, when the sensor is constructed for a particular analyte, the sensor can have a device that provides a signal when the second frequency is measured.

Another aspect of the invention provides a method for detecting a sample of an analyte, or the presence of a sample of an analyte. In one embodiment, the method involves providing at least one ion channel oscillating at a first frequency. When the analyte is present, the method involves allowing the sample to bind the ion channel to cause the ion channel to oscillate at a second frequency. As described previously, the method of the present invention provides the advantages of simultaneously measuring several binding events, increased sensitivity due to the characteristics of the ion channels and amplification techniques, and fast response times i.e. the time between the binding event and the measuring of the second frequency.

In one embodiment, the sensor can be constructed for a particular analyte by derivatizing the ion channel binding site with functional groups that facilitates binding of the analyte to the ion channel. The functional groups can be added chemically, especially in the case when the ion channel is a synthetic ion channel. Or, in the case of ion channels formed from naturally occurring species, the functional groups can be a varied by a variety of methods known in the art, involving a combination of molecular genetics, recombinant DNA techniques, site-directed mutagenesis, PCR-directed mutation, or by chemical synthesis of a gene encoding the protein subunit.

Sensors of the present invention exhibit fast response time i.e. the time between analyte binding to the ion channel and the second frequency is measured or detected. In one embodiment, the response time is less than about 1 s, preferably less than about 500 ms and more preferably less than about 100 ms.

Because the sensor can generate an electrical current greater than typical ion channels by one or two orders of magnitude, the sensitivity of the sensor is increased, allowing the detection of samples having very low amounts of analyte. In one embodiment, the amount of analyte in the sample is measured as a concentration of analyte present in the electrolyte, and the sensor of the present invention is capable of detecting analyte samples in the pM regime. In this embodiment, the amount of analyte in the sample is less than about 1 nM, preferably less than about 500 pM and more preferably less than about 100 pM.

As mentioned previously, the sensor of the present invention is particularly rugged and can operate constantly and thus the method can involve the ion channel operating constantly in the “on” position. That is, the sensor is made to oscillate steadily and variations in oscillation is indicative of a detectable change, such as presence of an analyte. Certain prior art devices, in contrast, require an activation step to “turn on” the device (begin oscillations), where the activation step can involve exposure to an energy source, such as light. Because the present invention does not require a separate activation step to turn on the sensor, analytes can be detected “passively” as opposed to “actively.” When an analyte is “actively” sensed, the operator is controlling the sensor and monitoring the sensor for the presence of the device. When an analyte is “passively” sensed, the sensor does not require monitoring. Passive sensors can be applicable when there is a need to detect, for example, a noxious biological or chemical species that is suspected to be present within the general area. Thus, a passive sensor does not require constant monitoring, but upon detection of a particular biological or chemical analyte, the sensor can generate a signal that indicates the presence of the analyte. Thus, one aspect of the invention is a method that involves long-term operation of an ion channel in an oscillating state, for example, at least one hour, at least one day, or at least one week, and after this period of time exposing the sensor to an analyte and allowing the oscillation frequency of the sensor to change and to be detected.

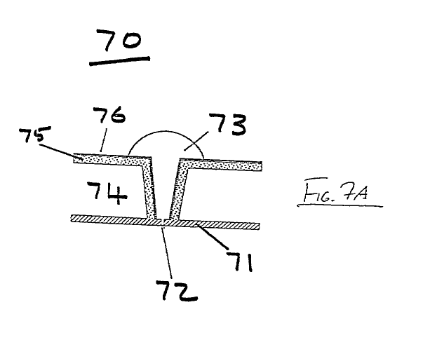

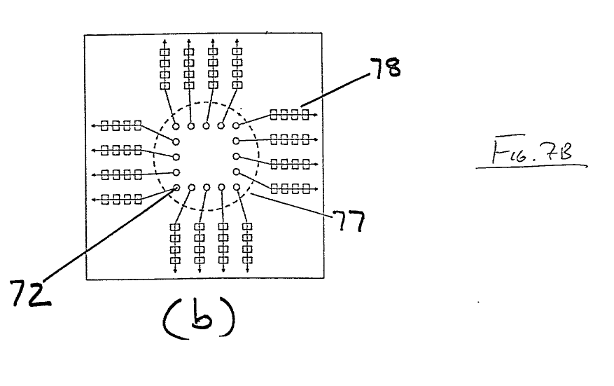

FIGS. 7A and 7B schematically illustrate a sensor in accordance with the present invention having an array of holes, each of which can contain an ion channel pore, fabricated using standard silicon technology with microholes made lithographically. FIG. 7(a) shows a side view of one hole in chip 70. Chip 70 includes an SiNₓ insulating barrier 71 having hole 72. In hole 72 resides a membrane having at least one pore. On the other side of the hole is a second electrolyte solution 73 which can comprise an extremely small volume such as a volume from a pipet tip. A silicon layer 74 can be positioned on the insulating layer 71 except in the area around hole 72. The silicon layer 74 can then be overlaid with a second insulating layer 75 (SiO₂). Electrode 76 can then positioned on insulating layer 75 such that electrode 76 is in contact with electrolyte solution 73.

FIG. 7(b) schematically illustrates a top view of a sensor chip 70 having an array of holes 72. The array of holes can be positioned on one side in a common electrolyte bath, and on the other side in contact with separate electrolyte baths 77 as shown in FIG. 7(b). Of particular interest in FIG. 7(b) is the presence of a series of amplifiers 78, for example gain stages, connected to each of holes 72. These amplifiers allow amplification of an oscillating electric current generated from the device. Thus, one aspect of the invention is an amplifier electrically connected to an ion channel. The array shown in FIG. 7(b) is not an n×m array, but rather an array outlining a square, to simplify showing connection of each hole to the series of amplifiers. Those of ordinary skill in the art can design an n×m array and connect each hole to a series of amplifiers based on the teachings herein. Such a chip not only provides an increased sensitivity but due to large number of holes present the result of any measurements derived from the sensor chip can be provided as a statistical result. A statistical result has the advantage over a device having only a single hole. For example, in the event that the ion channel or membrane or other features of the device around the hole malfunctions, resulting in the inability to detect an analyte, the lack of a signal cannot be definitively attributed to the lack of presence of an analyte. By this statistical method, one or even two malfunctioning holes will not prevent the detection of analytes, and in addition, the quantity, i.e., the strength of the signal detected, can be averaged over the number of holes.

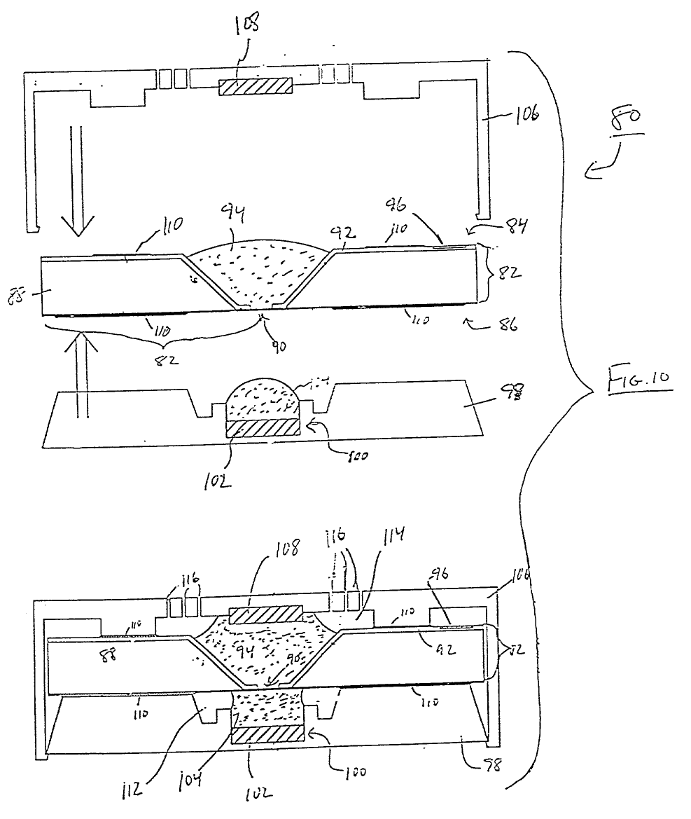

FIG. 10 illustrates, schematically, a sensor device 80 in accordance with one aspect of the invention in cross section. Device 80 is similar to device 50 of FIGS. 6A and 6B. A middle portion of device 80 includes a barrier 82, including a top side 84, and a bottom side 86 as oriented in the illustration. Area 82 includes a variety of components. It is based upon an annular silicon ring 88 that tapers, at its center, to a large (relatively) hole. A silicon nitride thin film layer is provided on the bottom side of silicon ring 88 which includes a hole 90 at its center, concentric with the hole in the center of silicon ring 88, but much smaller, on the order of 1 micron or less. The silicon nitride thin film extends centrally into the hole in ring 88 and defines part of the electrically insulating barrier. Although not shown, within hole 90 is a lipid bilayer membrane including an ion channel. An electrically insulating layer 92 covers the top side of silicon ring 88 and extends centrally beyond silicon ring 88 into the hole within ring 88 and onto the silicon nitride thin film but does not extend to hole 90. Thus silicon ring 88, the silicon nitride film, and electrically insulating layer 92 define barrier 82. Electrical amplifier circuits 96 can be provided and connected electrically to the ion channels within holes 90, as described above.

The tapering portion within the center of ring 88 is suitable for receiving an electrolyte solution 94 as a droplet therein. Below the bottom side of barrier 82 is provided a bottom component 98 of the device, made of Teflon™ or the like, which includes a center receptacle 100 positioned for alignment with hole 90. Receptacle 100 contains an electrode 102 (e.g. silver) and is suitable for receiving a second electrolyte solution 104 as a droplet therein. Device 80 also includes a top portion 106 made of Teflon™ or the like, including a second electrode 108 (e.g. silver) positioned in or near the center thereof. Bottom portion 98 and top portion 106 of device 80 are constructed of electrically insulating material and constructed to snap-fit together, sandwiching therebetween the middle portion of the device including barrier 82. Seals, such as Sylgard® seals 110 can be provided to mate with portions of bottom component 98 and top component 106 of device 80 to create isolated chambers containing electrolytes immediately above and below hole 90. When device 80 is assembled, electrolyte 94 and electrolyte 104 are brought into contact with opposite sides of hole 90 in barrier 82, thus in contact with opposite sides of the ion channel (not shown) within hole 90. Electrical circuitry (not shown) connects electrodes 102 and 108 for obtaining measurements as described above. Device 80, when assembled, includes a sealed bottom chamber 112 that contains electrolyte 104 and is bordered by electrode 102, interior surfaces of bottom component 98, the bottom side of silicon nitride film 110, and the bottom side of the lipid bilayer membrane and ion channel within hole 90. As illustrated, electrolyte 104 does not completely fill chamber 112. Instead, chamber 112 also includes air outside of electrolyte 104 that allows for expansion and contraction of electrolyte 104 upon variation in temperature. A top chamber 114 is defined upon assembly of the device that includes electrolyte 94 and is bordered by the top side of barrier 82, an interior surface of top component 106, and the top side of silicon nitride film and the lipid bilayer and pore within hole 90. Chamber 114 also is not completely filled by electrolyte 94, but includes air outside of the boundary of electrolyte 94. When assembled, electrolyte 104 is in contact with electrode 102, and electrolyte 94 is in contact with electrode 108, each electrolyte being in contact with the pore within hole 90. Top component 106 includes passages 116 within a wall thereof for exposure of electrolyte 94 to a fluid suspected of containing an analyte that can interact with the pore within hole 90 to affect oscillation frequency. When the sensor is exposed to air containing such an analyte, for example, the analyte passes through passages 116, diffuses through electrolyte 94, binds to the pore within hole 90, and its presence is sensed.

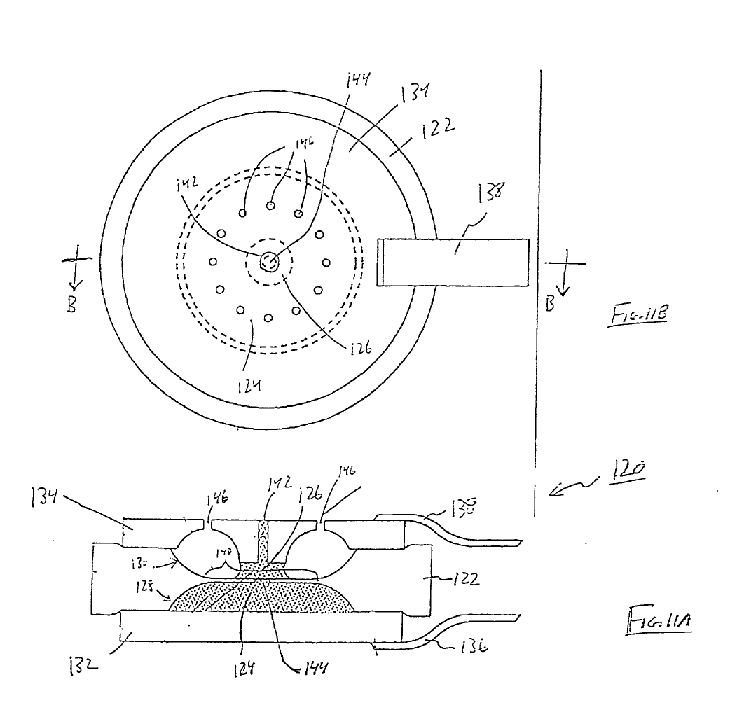

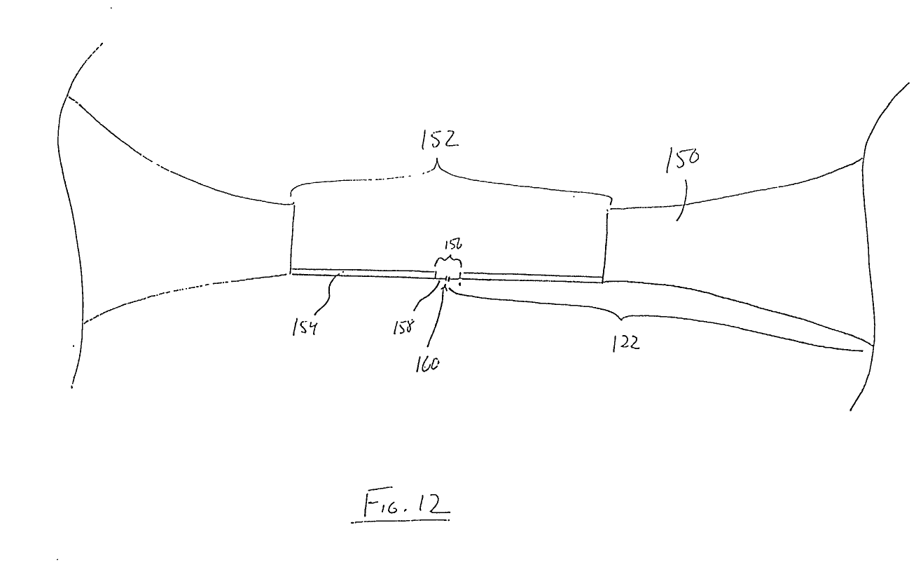

FIGS. 11A and 11B illustrate, schematically, another sensor device 120 of the invention. Device 120 is similar to devices 50 and 80 of FIGS. 6A-6B and 10, respectively. FIG. 11B is a top view of sensor 122, and FIG. 11A is a cross-section through lines B-B of FIG. 11B, showing a barrier 122 separating electrolytes 124 and 126 within bottom and top containers 128 and 130, respectively, defined by connection of bottom component 132 and 134, respectively, to barrier 122. As illustrated, bottom component 132 defines, itself, an electrode addressed by an electrical lead 136, and top component 134 defines an electrode addressed by an electrical lead 138. Electrolyte solution 124 completely fills bottom container 128, but electrolyte solution 126 only partially fills top container 130, the remainder of which is filled with air. This partially assists in compensating for expansion and contraction of the electrolyte. Electrical leads 136 and 138 can connect to an amplifier circuit on a chip.

It is an important feature of the embodiment illustrated in FIGS. 11A and 11B that barrier 122 differs from barriers described with reference to earlier illustrations in that it includes a central portion 140 that is flexible enough to adjust for thermal expansion and contraction of electrolyte 124 in bottom container 128 to the extent that electrolyte 124 can completely fill bottom container 128 without void space. Central portion 140 is sufficiently flexible due to its thinness, and/or the material from which it is made. Preferably, for purposes of simplicity in fabrication and assembly, a single material defines the entire barrier 122 including central portion 140. This material should be selected among any that allows sufficient flexibility, and compatibility with material defining electrolytes 124 and 126 (i.e., it is not degraded by the electrolyte and does not leach components into the electrolyte that would affect operation of the device). The material selected should be electrically insulating, with a low dielectric constant. Those of ordinary skill in the art can select suitable material. Electrolytes 124 and 126 typically are aqueous electrolytes, and in this case material defining barrier 122 can be selected among many known soft plastics including polyolefins such as polyethylene, polypropylene, etc., or the like. Generally, polymers with small side groups on their backbones are relatively flexible because of low steric hinderance and are suitable for use. Top component 134 includes a central passageway 142 for introduction of electrolyte 126 into chamber 130 in contact with thin film 144 and peripheral passages 146 that allow introduction of analyte-containing fluid (e.g., air) into chamber 130 for diffusion through electrolyte 126 into contact with the pore mounted within thin film 144. Thin film 144 includes a nanoscale hole including an ion channel defining a pore, within a lipid bilayer.

Referring now to FIG. 12 an expanded, cross-sectional cutaway view of the hole in barrier 122 of FIGS. 11A and 11B is illustrated schematically. Barrier 122 is made up of soft plastic component 150, including a central, circular void 152. Annular thin film barrier component 154, made of silicon nitride, diamond-like carbon, or the like, covers most of central void 152 with the exception of a small circular hole 156 in its center having a diameter of less than about 1 micron or other, smaller dimensions as described above. Within central hole 156 is lipid bilayer membrane barrier component 158 containing, typically at or near its center, biological ion channel 160. Thus, electrically insulating barrier 122 is defined by annular soft plastic member 150, annular thin film 154 within void 152 of member 150, and annular lipid bilayer membrane 158 within hole 156 of thin film 154.

The function and advantage of these and other embodiments of the present invention will be more fully understood from the examples below. The following examples are intended to illustrate the benefits of the present invention, but do not exemplify the full scope of the invention.

### EXAMPLE

This example describes the preparation of a device incorporating a biological oscillating ion channel. The ion channel comprised an array of the subunit c of ATP synthase. Isolation of this ion channel was performed as reported in Brain Research, Vol. 766, pp. 188-894 (1997, McGeoch et al.).

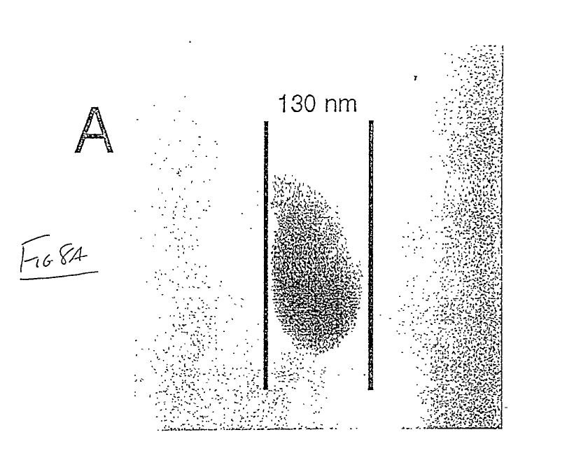

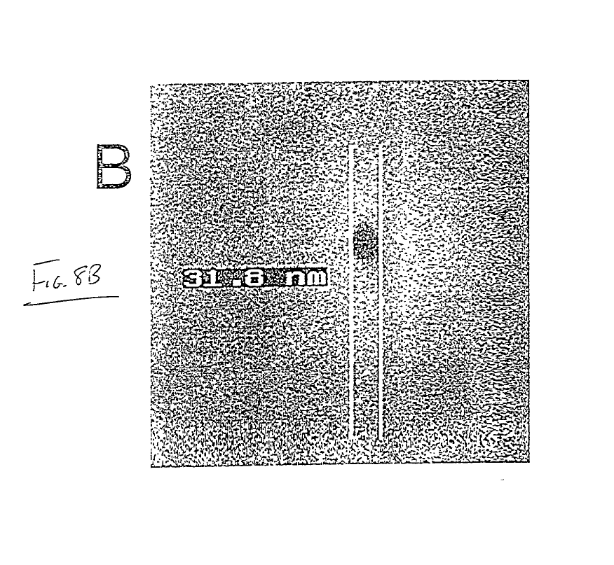

The ion channel was positioned within a hole of a 250 nm thick SiNₓ insulating layer. The dimensions of the hole were 130 nm×180 nm, the hole being patterned by direct-write electron beam lithography and reactive ion etching. FIGS. 8A and B shows photocopies of SEM images of nanofabricated holes in SiNx membranes. FIG. 8A shows 130×180 nm hole in a 250 nm thick SiNx membrane which was patterned by direct write electron beam lithography and reactive ion etching. FIG. 8B shows a 31 nm hole in a 1.1 μm thick SiNₓ membrane which was patterned by focused ion beam milling.

FIG. 8 shows a photocopy of an SEM of this nanofabricated hole.

This insulating layer was incorporated into a device as shown in FIG. 6A. The bilayers of reconstituted protein in lipid vesicles and electrolytes were prepared as described in McGeoch et al (p. 189, section 2.4). The silicon layer had dimensions of 12 mm×12 mm×1 mm and the silicon nitride layer had dimensions of 4 mm×4 mm×250 nm. The electrolyte solutions were contained in a 4 mm×4 mm×4 mm teflon holder.

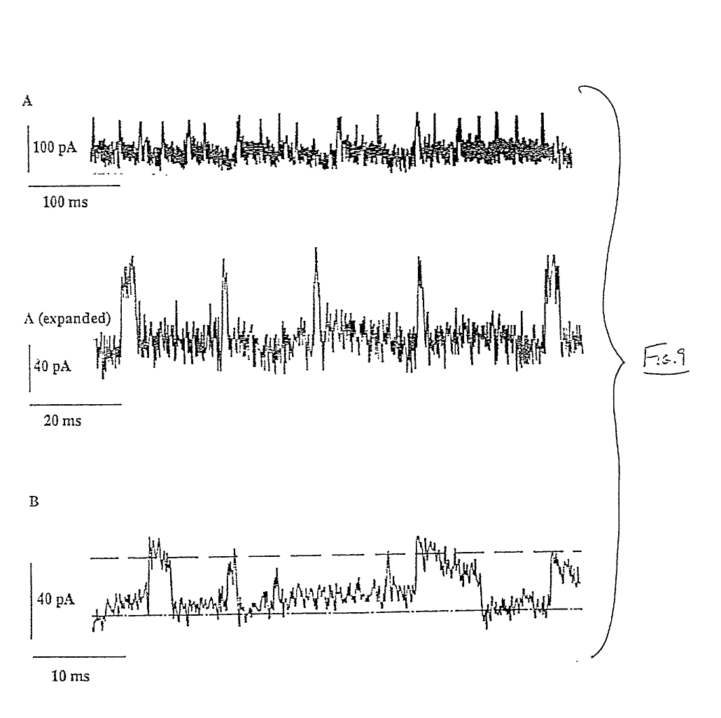

FIG. 9 shows a current vs. time plot, indicating the oscillation of the ion channel in the device. The oscillation frequency can be varied as shown in plots (a) and (b). FIG. 9 shows that the same oscillating current is obtained in the SiNₓ barrier holes of the invention as is present in prior art patch clamp assays involving a glass micropipette barrier with a one micron hole. In plot (a), the SiNₓ barrier was 250 nanometers thick and the hole was of dimension 130×180 nanometers in diameter. Plot (b): SiNₓ barrier 1.1 micron thick and a hole of 50 nanometers diameter. Both holes were patterned by focus ion beam milling.

Those skilled in the art would readily appreciate that all parameters listed herein are meant to be exemplary and that actual parameters will depend upon the specific application for which the methods and apparatus of the present invention are used. It is, therefore, to be understood that the foregoing embodiments are presented by way of example only and that, within the scope of the appended claims and equivalents thereto, the invention may be practiced otherwise than as specifically described.

What is claimed is:

1. A device for generating an oscillating current, comprising:
an insulating layer positioned between at least two electrolyte reservoirs;
a negative bias electrode and a positive bias electrode, each electrode having one end in electrical communication with respective electrolyte reservoirs, the other ends of the electrodes being connected to a voltage source for applying a voltage and a current detector for measuring current;
at least one hole penetrating the insulating layer;
at least one pore positioned within each of the at least one hole, the at least one pore existing in one of an open and a closed state, wherein the closed state prevents ionic communication between the reservoirs and the open state allows ionic communication between the reservoirs to generate electrical current.

2. A device as in claim 1, wherein the at least one hole has a diameter of less than about 1 μm.

3. A device as in claim 1, wherein the at least one hole has a diameter of less than about 500 nm.

4. A device as in claim 1, wherein the at least one hole has a diameter of less than about 300 nm.

5. A device as in claim 1, wherein the at least one hole has a diameter of less than about 100 nm.

6. A device as in claim 1, wherein the at least one pore has a diameter of less than about 10 angstroms.

7. A device as in claim 1, wherein the at least one pore has a diameter of between about 3 angstroms and about 10 angstroms.

8. A device as in claim 1, further comprising the at least one pore being positioned in a lipid bilayer positioned within each of the at least one hole.

9. A device as in claim 8, wherein the at least one pore comprises the pore of an ion channel.

10. A device as in claim 8, wherein the ion channel comprises a closed ring arrangement of protein subunits.

11. A device as in claim 10, wherein the closed ring arrangement of protein subunits comprises at least 3 protein subunits.

12. A device as in claim 11, wherein the closed ring arrangement of protein subunits comprises between 3 and 15 protein subunits.

13. A device as in claim 12, wherein the closed ring arrangement of protein subunits comprises between 6 and 12 protein subunits.

14. A device as in claim 13, wherein each of the protein subunits is subunit c of ATP synthase.

15. A device as in claim 9, wherein the ion channel is selected from the group consisting of a sodium ion channel, a potassium ion channel, a calcium ion channel and combinations thereof.

16. A device as in claim 9, wherein the ion channel is a sodium/calcium ion channel.

17. A device as in claim 1, wherein the oscillation has a frequency of between about 0.1 Hz and about 700 Hz.

18. A device as in claim 1, wherein the current has a value of at least about 10 pA upon applying a voltage of between about 60 mV to about 100 mV.

19. A device as in claim 1, wherein the current has a value of at least about 50 pA upon applying a voltage of between about 60 mV to about 100 mV.

20. A device as in claim 1, wherein the current has a value of at least about 100 pA upon applying a voltage of between about 60 mV to about 100 mV.

21. A device as in claim 1, wherein the current has a value of at least about 200 pA upon applying a voltage of between about 60 mV to about 100 mV.

22. A device as in claim 1, further comprising an array of holes penetrating the insulating layer, and a separate electrolyte reservoir contacting each hole on at least one side of the insulating layer.

23. A device as in claim 22, wherein the array of holes is an n×m array and n and m can be the same or different and each of n and m is an integer of at least 2.

24. A device as in claim 1, further comprising an amplifier to amplify the generated electrical current.

25. A device for generating an oscillating current, comprising an oscillating ion channel, wherein the ion channel is positioned within a membrane spanning a hole having a diameter less than 1 μm.

26. A device as in claim 1, wherein the at least one hole has one common electrolyte reservoir.

27. A method, comprising:
providing at least one membrane positioned between two electrolyte reservoirs, the membrane having at least one oscillating ion channel, and measuring an electrical output from the oscillating ion channel in the membrane.

28. A method as in claim 27, wherein the ion channel oscillates steadily for at least 1 day.

29. A method as in claim 27, wherein the ion channel is selected from the group consisting of a sodium ion channel, a potassium ion channel, a calcium ion channel and combinations thereof.

30. A method as in claim 29, wherein the ion channel is a sodium/calcium ion channel.

31. A method as in claim 30, wherein the sodium/calcium ion channel is formed from a closed ring arrangement of protein subunits.

32. A method as in claim 31, wherein each of the protein subunits is subunit c of ATP synthase.

33. A method as in claim 30, wherein each of the protein subunits is stable for a period of at least one day upon being stored in an organic solvent under an ambient atmosphere.

34. A sensor, comprising:
an insulating layer positioned between two electrolyte reservoirs;
a negative bias electrode and a positive bias electrode, each electrode having one end in electrical communication with respective electrolyte reservoirs, the other ends of the electrodes being connected to a voltage source for applying a voltage and a current detector for measuring current;
at least one hole penetrating the insulating layer; and
an ion channel positioned within the hole.

35. A sensor as in claim 34, further comprising one of the two electrolyte reservoirs being exposed to an atmosphere suspected of containing the analyte.

36. A method for detecting a sample of analyte, comprising:
providing at least one ion channel oscillating at a first frequency;
allowing the sample to bind to the at least one ion channel to cause the ion channel to oscillate at a second frequency; and
measuring the second frequency.

37. A method as in claim 36, wherein the providing step further comprises:
positioning the at least one ion channel into each of the at least one hole penetrating an insulating layer, the insulating layer being positioned between two electrolyte reservoirs; and
immersing one end of each of a negative bias electrode and a positive bias electrode into respective electrolyte reservoirs, the other ends of the electrodes being connected to a voltage source for applying a voltage and a detector for measuring current.

38. A method as in claim 36, wherein a time between the binding and measuring the second frequency is less than about 1 s.

39. A method as in claim 36, wherein a time between the binding and measuring the second frequency is less than about 500 ms.

40. A method as in claim 36, wherein a time between the binding and measuring the second frequency is less than about 100 ms.

41. A method as in claim 36, wherein the amount of analyte in the sample is less than about 1 nM.

42. A method as in claim 36, wherein the amount of analyte in the sample is less than about 500 pM.

43. A method as in claim 36, wherein the amount of analyte in the sample is less than about 100 pM.

44. A method as in claim 36, further comprising derivatizing the ion channel with functional groups to detect a predetermined analyte.

45. A method as in claim 36, wherein the first frequency is at least 0.1 Hz.

46. A device comprising:
an ion channel capable of oscillation; and
an electrical amplifier in electrical communication with the ion channel.

47. A device as in claim 46, further comprising an electrical insulator, wherein the ion channel is located in a hole in the barrier passing from a first side of the insulator to a second side of the insulator, the device further comprising first and second electrolyte reservoirs positioned on respective sides of the barrier and contacting first and seconds ends of the hole, and electrical circuitry constructed and arranged to apply potential across the hole and to measure a change in electrical characteristic resulting in a change in oscillation frequency of the ion channel, amplified by the amplifier.

48. A device comprising:
a barrier having a first side and a second side;
a pore in the barrier, existing in one of an open and a closed state, the closed state preventing ionic communication across the pore and the open state allowing ionic communication across the pore from the first side of the barrier to the second side of the barrier;
a first electrolyte container, constructed and arranged to contain an electrolyte and to position the electrolyte in contact with the a first side of the pore, including container interior walls integral with the barrier; and
a second electrolyte container, constructed and arranged to contain an electrolyte and to position the electrolyte in contact with a second side of the pore, including container interior walls integral with the barrier.

49. A device comprising:
a barrier having a first side and a second side;
a pore in the barrier, existing in one of an open and a closed state, the closed state preventing ionic communication across the pore and the open state allowing ionic communication across the pore from the first side of the barrier to the second side of the barrier;
a first electrolyte container, constructed and arranged to contain an electrolyte and to position the electrolyte in contact with the a first side of the pore; and
a second electrolyte container, constructed and arranged to contain an electrolyte and to position the electrolyte in contact with a second side of the pore, and fastenable to the first electrolyte container.

50. A device comprising:
a barrier having a first side and a second side;
a pore in the barrier, existing in one of an open and a closed state, the closed state preventing ionic communication across the pore and the open state allowing ionic communication across the pore from the first side of the barrier to the second side of the barrier;
a first electrolyte container, fastenable to the barrier, constructed and arranged to contain an electrolyte and to position the electrolyte in contact with a first side of the pore; and
a second electrolyte container, fastenable to the barrier, constructed and arranged to contain an electrolyte and to position the electrolyte in contact with a second side of the pore.

51. A device as in any of claims 48-50, wherein the barrier includes an electrical insulator.

52. A method for generating at least one oscillating current, comprising providing at least two separate membranes positioned adjacent at least one electrolyte reservoir, each membrane having at least one oscillating ion channel, and simultaneously measuring an electrical output from the at least one oscillating ion channel in each membrane.

53. A device comprising:
a first electrolyte reservoir;
a second electrolyte reservoir;
electrical circuitry connecting the first and second electrolyte reservoirs; and
subunit c of ATP synthase separating first and second electrolyte reservoirs.

54. A device or method as in any preceding claim, including a hole spanned by an insulating membrane containing a pore.

55. A device or method as in any preceding claim, including subunit c of ATP synthase or a derivative.
